(19) United States
(12) Patent Application Publication
(10) Pub. No.: US 2009/0055404 A1
(43) Pub. Date: Feb. 26, 2009

(54) SYSTEM AND METHOD FOR ONLINE PROFILE MANAGEMENT

(75) Inventors: Clint F. Heiden, McLean, VA (US); Phillip Merrick, McLean, VA (US); Eric C. Dean, Ashburn, VA (US); Douglas E. Meadows, Ashburn, VA (US); Karle L. Durante, Ashburn, VA (US); Scott Herman, Chantilly, VA (US)

Correspondence Address: MORRISON & FOERSTER LLP, 1650 TYSONS BOULEVARD, SUITE 400, MCLEAN, VA, 22102, US

(73) Assignee: VisualCV, Inc., Reston, VA (US)

(21) Appl. No.: 12/191,155

(22) Filed: Aug. 13, 2008

Related U.S. Application Data
(60) Provisional application No. 60/955,573, filed on Aug. 13, 2007.

(51) Int. Cl. G06F 17/30

(52) U.S. Cl. 707/10; 707/E17.01

(57) ABSTRACT

An online profile management system and method is disclosed that provides users with management and control over the presentation and distribution of their online profiles. The system can enable a user to create a professional profile for purposes such as job seeking, career management and/or professional networking, for example. The online profile can cut out time and expense for both an applicant and employer by combining an applicant's resume, interview audio and video, and a digital career portfolio into a compelling package hosted on a single, easy-to-use Web page. The Internet-based profile can also enable professionals to build and manage an online career portfolio that comes alive with informational keyword pop-ups, video, pictures, and social networking. The system can enable secure sharing of the online profile and interaction with others for purposes of networking, discussing best practices, career progression and business development, for example.

### CROSS REFERENCE TO RELATED APPLICATION

This application claims priority under 35 USC 119(e) to U.S. Provisional Application No. 60/955,573, filed Aug. 13, 2007, the entirety of which is incorporated herein by reference.

### FIELD OF THE INVENTION

This relates to online user profiles, and more particularly, to managing and controlling the presentation and distribution of online user profiles.

### BACKGROUND

The Internet has revolutionized entire industries by organizing and delivering robust information using a simple multimedia interface. While the Internet has primarily enabled businesses to operate more efficiently, for employers, the Internet has overwhelmed them with a continuous supply of job applicants and resumes. Prior to the Internet, applicants would either hand-deliver or postage-mail resumes for advertised jobs. Now, both qualified and unqualified worldwide applicants simultaneously submit their resumes over the Internet to a multitude of jobs. As a result, employers receive many times more resumes than in the past and have difficulty discerning qualified applicants from unqualified. Ironically, applicants can once again distinguish themselves by sending a postage-based paper resume directly to an employer.

Resumes lack a standard format and contain varying degrees of details and structure often resulting in subjective interpretation of content and qualification. Therefore, employers must perform additional research to determine the relevancy of past experience, skills, and employers with respect to a job opportunity. In addition, an unqualified applicant may acquire the necessary education, skills, and experience for a job within a short period of time. Since employers retain outdated versions of resumes, an applicant's more recently acquired qualifications can remain unknown to the employers.

Accordingly, the static and text-based resume document has become an inefficient and time-consuming way for applicants to effectively represent themselves to employers.

### SUMMARY

An online profile management system is disclosed that can provide users with management and control over the presentation and distribution of their online profiles.

In one embodiment, the system can enable a user to create a professional profile for purposes such as job seeking, career management and/or professional networking, for example. The online profile can cut out time and expense for both an applicant and employer by combining an applicant's resume, interview audio and video, and a digital career portfolio into a compelling package hosted on a single, easy-to-use Web page. The Internet-based profile can also enable professionals to build and manage an online career portfolio that comes alive with informational keyword pop-ups, video, pictures, and social networking. The system can enable secure sharing of the online profile and interaction with others for purposes of networking, discussing best practices, career progression and business development, for example.

### BRIEF DESCRIPTION OF THE DRAWINGS

FIG. 1 illustrates an example of a network architecture in accordance with one embodiment.

FIG. 2 illustrates an example of profile generation process in accordance with one embodiment.

FIG. 3 illustrates an example of a structure of an online profile in accordance with one embodiment.

FIG. 4 illustrates an example of a structure of multiple versions of an online profile in accordance with one embodiment.

FIG. 5 illustrates an example of a version control process in accordance with one embodiment.

FIG. 6 illustrates an example of a notification control process in accordance with one embodiment.

FIG. 7 illustrates an example of an authorization control process in accordance with one embodiment.

FIG. 8 illustrates an example of single command notification process in accordance with one embodiment.

FIG. 9 illustrates an example of profile view tracking process in accordance with one embodiment.

FIG. 10 illustrates an example of a profile distribution process in accordance with one embodiment.

FIG. 11 illustrates an example of a profile verification process in accordance with one embodiment.

FIGS. 12A and 12B illustrate an example of a user dashboard in accordance with one embodiment.

FIGS. 13A-13C illustrate an example of a profile generation user interface in accordance with one embodiment.

FIG. 14 illustrates an example of computing device in accordance with one embodiment.

### DETAILED DESCRIPTION

Embodiments of the present invention provide a system that enables users to manage and control the presentation and distribution of online profiles. The online profiles can represent any type of entity, such as an individual or organization for example.

In one aspect, an online profile can enable individuals to distinguish themselves professionally by presenting their background and qualifications in a unique and compelling interactive format. The online profile can replace the traditional resume document with rich multimedia content on a network, such as on a website on the Internet, for example. While a traditional resume typically consists of a one or two page format, an online profile is not constrained by length but instead can provides great depth of details, information, and verified sources.

To create an online profile, an individual can electronically upload a current resume or CV into the system, or create one from scratch by manually supplying information into the system. The information can be stored in a database whereby the individual can later update the online profile with additional information in the form of text, images, charts, video, audio and multimedia documents (e.g., PowerPoint presentations), for example. The system can also provide a variety of templates and background color schemas, for example, from which the individual may select to customize the online profile's look-and-feel.

The system can provide access control mechanisms in connection with the viewing and dissemination of the online profile. For example, the system can enable an individual to share the online profile directly with another individual or organization associated with the system or across a network. The system can require authentication of an entity requesting to view the online profile, and restrict unauthorized access to profile information indicated as private. The system can also enable the individual to create and maintain multiple versions of the online profile, and share the different versions of the online profile with different entities as specified by the individual.

The system can further provide verification mechanisms in connection with the online profile. For example, the system can verify claims or representations made in user-supplied profile information. The system can also embed verified information supporting those claims into the online profile (e.g., definitions of acronyms, terms, organization information, etc.). The system can also incorporate into the online profile validation information that certifies credentials identified in the user-supplied profile information (e.g., education and professional licenses). The validation information can be provided by a third party verification service and be incorporated into the online profile in a secure manner.

The online profile can also serve as a career portfolio—a central repository for professional information representing an individual's entire career. The portfolio information provided by the individual can be maintained by the individual and owned by the individual. With this portfolio, rather than being primarily “event driven” by the individual, the online profile can be “career driven” in the sense that it allows for the individual to maintain a presence and networking capability with key organizations regardless of the individual's current professional status. This manner of brand management can be achieved, for example, by incorporating the network address for the individual's online profile in the individual's e-mail signature line and/or business cards, for example. The system can also further this “career driven” aspect of the online profile by providing a notification process that would alert the individual when a professional certification identified in the online portfolio is due for renewal, for example.

The system can further provide data portability in connection with the online profile. In one embodiment, the system can enable an individual to synchronize online profiles maintained by the individual at different network locations (e.g., in different online communities). In another embodiment, the system can enable the individual to convert the online profile to or from other platforms such as social networking sites, job boards, Applicant Tracking Systems and Talent Management Systems, for example. The system can enable the conversion of entire resume databases to the format of the online profile, and enable automatic updates to those databases when desired by individuals. Accordingly, at the discretion of the individual, the online profile can automatically update organizations and resume databases selected by the individual, ensuring that information is fresh and maintained at those locations. Without this option, individuals would find it difficult to update multiple sites and would eventually begin to opt-out of manually updating multiple destinations—creating a disadvantage for both individuals and organizations.

Organizations and other entities can also generate online profiles on the system. The system can provide an electronic marketplace in which individuals and organizations can search for and/or be matched with one another based on information provided in their respective online profiles.

In one embodiment, a system hosting the online profile and implementing the associated functionality described above may command revenue from at least two sources: the individual (via the use of the system in generating and providing an online profile or in providing other services, such as resume writing help, background check certification, and candidate searches for example) and the organization (via the ability to access or perhaps host the system for example).

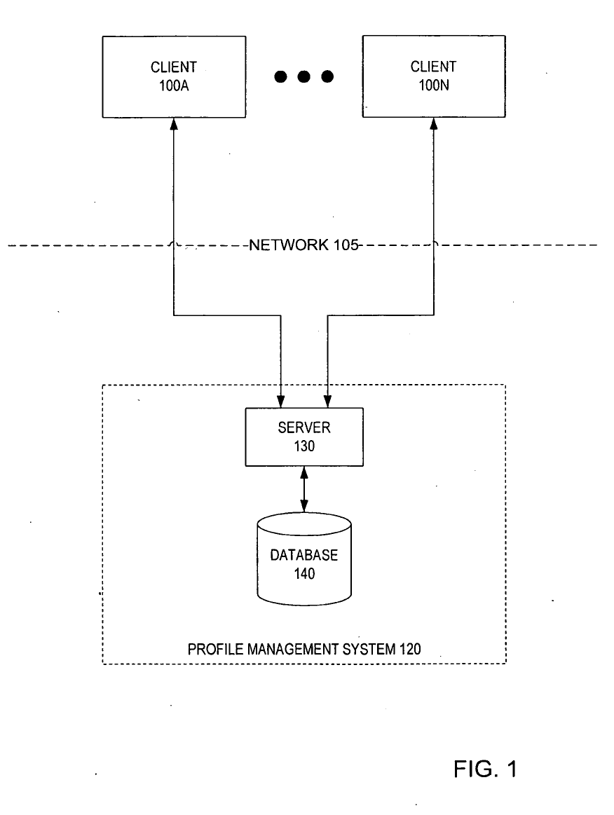

FIG. 1 illustrates an example of a network architecture in accordance with one embodiment. In the embodiment illustrated in FIG. 1, profile management system 120 generally corresponds to the system described above, and clients 100a-100n comprise computers operated by users of system 120 to access and manage online profiles hosted by system 120 over network 105. Profile management system 120 can include server 130 and database 140. Database 140 can store, for example, the content comprising users' online profiles. Server 130 can implement the functionality of system 120 as described herein corresponding to the generation and management of the users' online profiles. In the following embodiments, user 205 and user 505 can represent users of system 120.

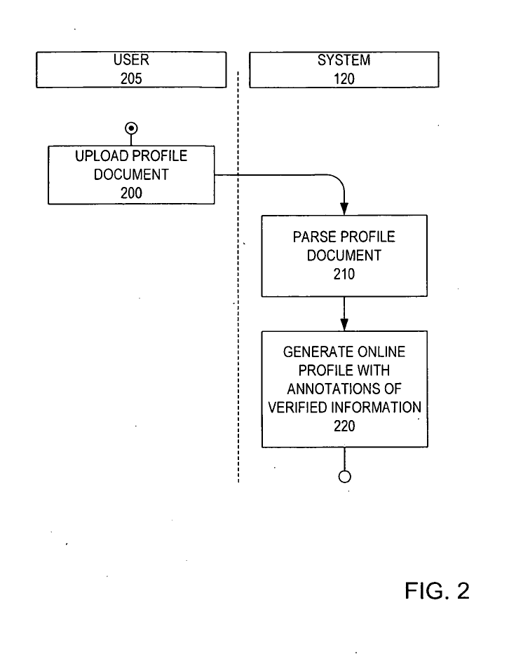

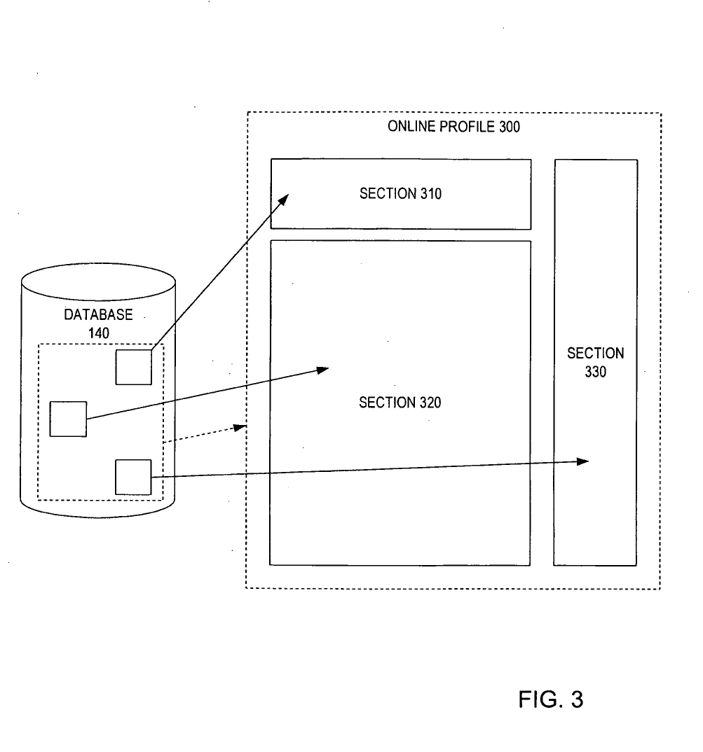

FIG. 2 illustrates an example of profile generation process in accordance with one embodiment. In the embodiment illustrated in FIG. 2, user 205 can upload (step 200) an electronic copy of a profile document (such as a resume document, for example) to system 120. Upon receipt of the document, system 120 can automatically recognize and parse (step 210) the document to identify the document's constituent sections (e.g., summary section, work history section, education section, etc. of a resume document). After the document is parsed, system 120 can generate (step 220) an online profile in part by formatting and storing the identified sections in database 140 as depicted in FIG. 3. During the generation process, system 120 can identify particular organizational entities (e.g., company or university names) parsed from the uploaded document, and cross-check that information for accuracy with verified listings from another database or source, for example. System 120 can then annotate the organization information stored in association with the generated online profile by associating URL links and/or other informational metadata (e.g., full organization name, address, web address, etc.) thereto.

The online profile can be configured so that cursor movement over certain highlighted data (e.g., organizational information) can cause a hover window to pop up to provide the informational metadata described above. The online profile can also be interactive in that it may enable toggling through performance charts, viewing of attachments, watching of attached videos or following of links to the Internet, for example.

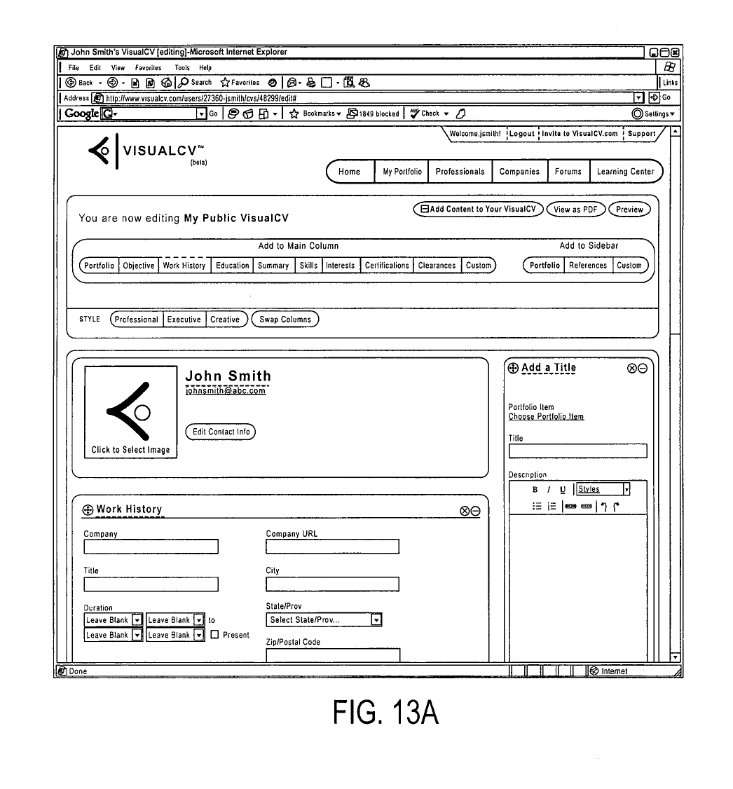

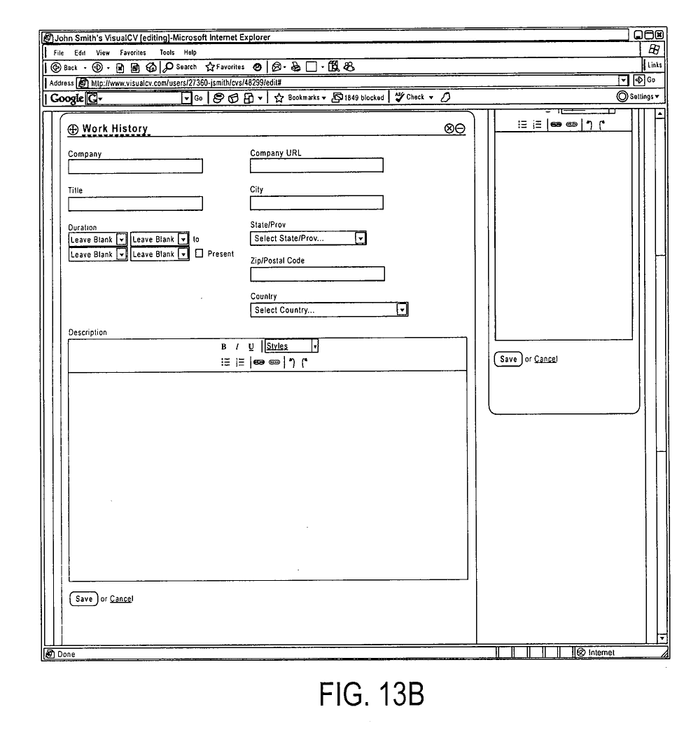

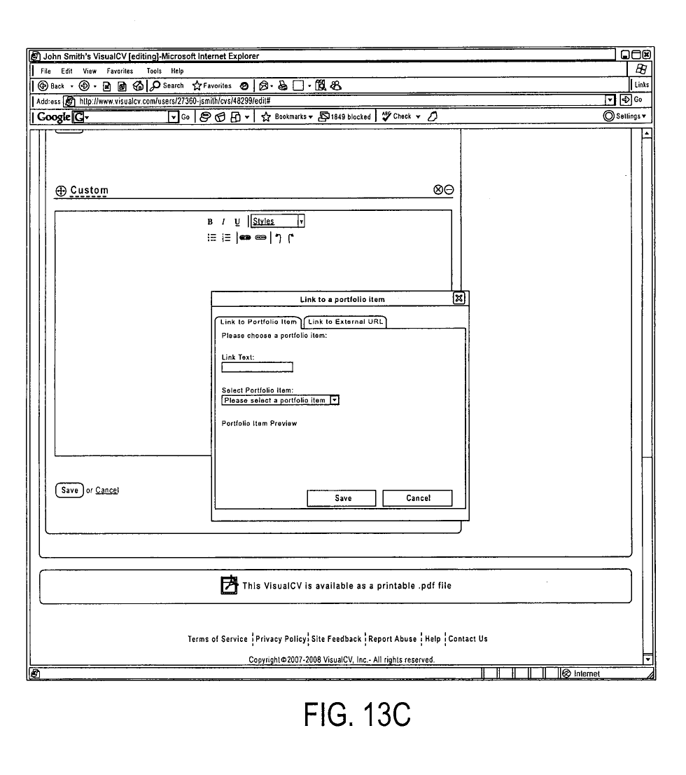

System 120 can also provide a user interface to enable user 205 to create an online profile in conjunction with or without uploading a profile document as described above. The user interface can enable user 205 to add or edit information corresponding to online profile sections in accordance with a predefined category specified by the user interface, and in accordance with a custom category specified by user 205 through the user interface. The user interface can enable user 205 to insert text or upload media objects of different types, such as images, video, audio and multimedia documents, to be incorporated into one or more of the sections of the online profile. FIG. 13 illustrates an example of an exemplary user interface for generating an online profile. The user interface can also enable user 205 to create different versions of the online profile.

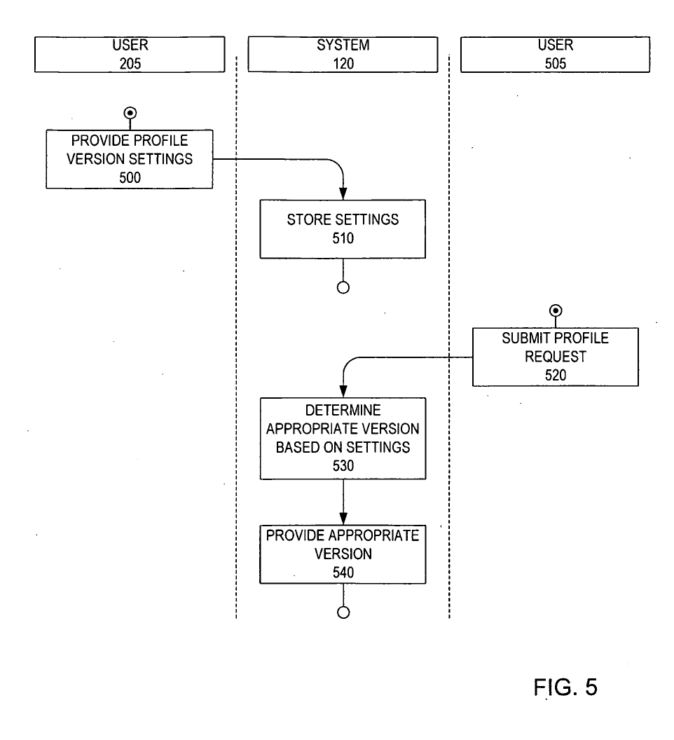

FIG. 3 illustrates an example of a structure of an online profile in accordance with one embodiment. In the embodiment illustrated in FIG. 3, database 140 can store sections 310, 320 and 330 in association with online profile 300. System 120 can dynamically assemble the stored sections into a rendered presentation layout when requested. System 120 can assemble the online profile in various ways based on the particular request, such as in accordance with version, notification and permission settings defined by user 205, for example. Embodiments of the implementation of these settings are depicted in the processes described in FIGS. 5-7.

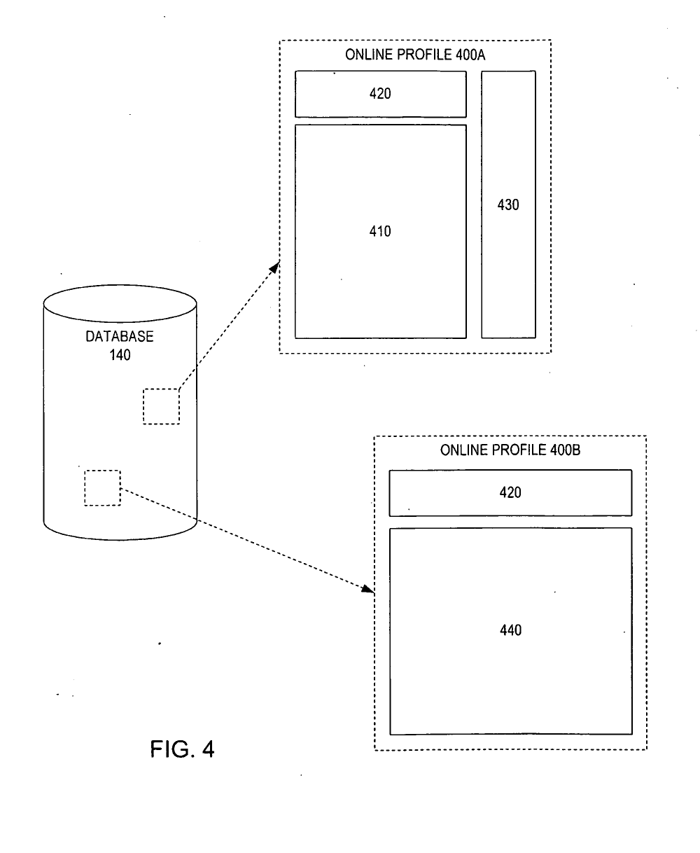

FIG. 4 illustrates an example of a structure of multiple versions of an online profile in accordance with one embodiment. In the embodiment illustrated in FIG. 4, database 140 can store sections 410, 420 and 430 in association with online profiles 400A and 400B. Profiles 400A and 400B can comprise different versions of an online profile of an entity. The different versions can share similar sections, such as section 420. Enabling a user to create multiple versions of an online profile can be advantageous if the user desires to tailor individual profiles for different recipients (e.g., such as different resumes for different employers).

FIG. 5 illustrates an example of a version control process in accordance with one embodiment. In the embodiment illustrated in FIG. 5, system 120 can provide a user interface that enables user 205 to specify (step 500) settings indicating which version of user 205's online profile is to be provided to an entity requesting to view the profile. System 120 can store the version settings (step 510). Upon receiving a request for the online profile (step 520) from user 505, system 120 can determine (step 530) the appropriate version of the online profile to provide (step 540) to user 505 based on the stored settings. In one embodiment, the version settings can enable user 205 to associate a version of an online profile with i) all profile requests originating from an entity not registered with profile management system 120 or ii) any particular registered user or users of system 120. System 120 may provide the online profile to user 505 in different ways, such as by allowing user 505 to view the online profile through a web page hosted by profile management system 120, or by converting the online profile to a downloadable format and downloading the converted profile to user 505 for example.

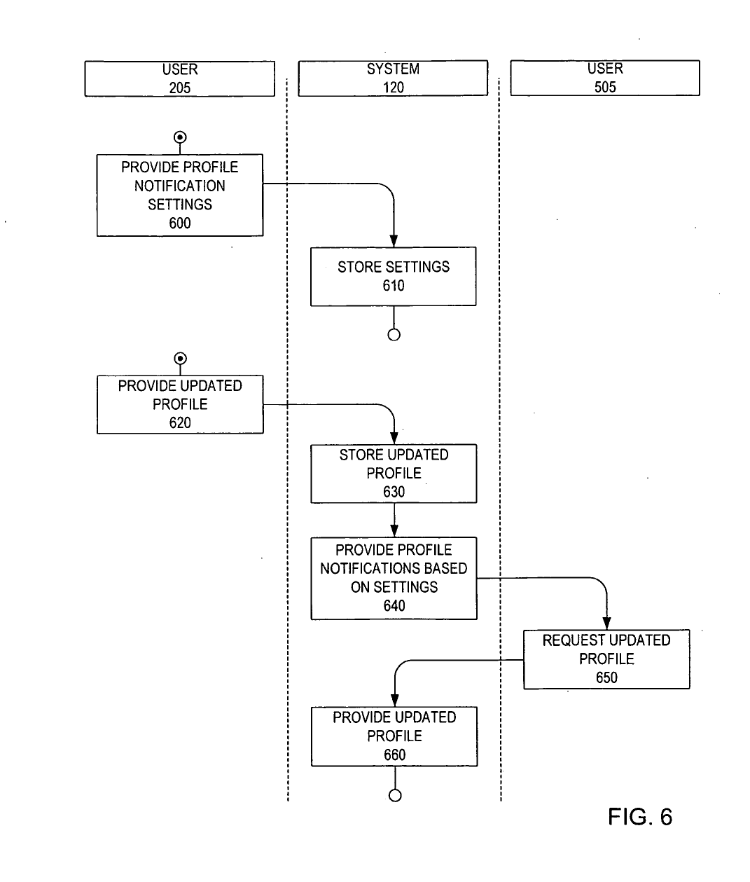

FIG. 6 illustrates an example of a notification control process in accordance with one embodiment. In the embodiment illustrated in FIG. 6, system 120 can provide a user interface that enables user 205 to specify (step 600) settings indicating who should be notified of any updates or changes made to the online profile. System 120 can store the notification settings (step 610). When user 205 provides (step 620) an update or change in the online profile, server 100 can store the updated profile (step 630) and provide (step 640) a notification to the entities identified in the notification settings, such as user 505 in this example. In one embodiment, the notification may comprise an e-mail announcing the change in the online profile along with an invitation to log into system 120 to view or access the updated online profile. When user 505 requests (step 650) the updated profile in response to the notification, system 120 can provide (step 660) the updated profile to user 505 in response to the request. In an alternative embodiment, the notification could comprise system 120 converting the online profile to a downloadable format and downloading the converted profile to the entities identified in the notification settings in step 640.

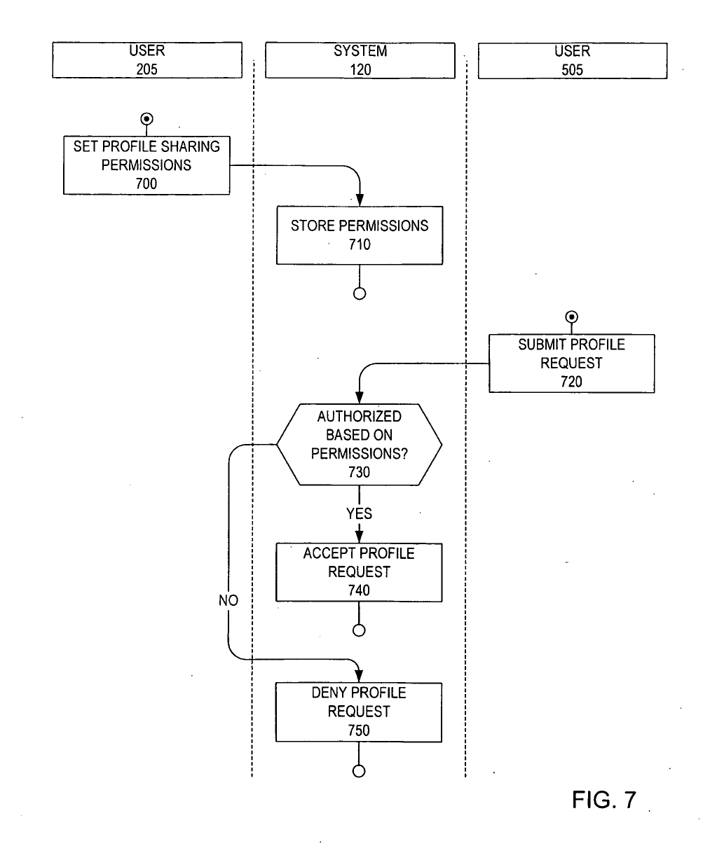

FIG. 7 illustrates an example of an authorization control process in accordance with one embodiment. In the embodiment illustrated in FIG. 7, system 120 provides a user interface that enables user 205 to specify (step 700) settings indicating who is permitted to access user 205's online profile through system 120. System 120 can store the permission settings (step 710). When user 505 submits (step 720) a request for the online profile, server 100 can determine (step 730) whether user 505 is permitted to access the online profile based on the stored permission settings, and accept (step 740) or deny (step 750) the request accordingly.

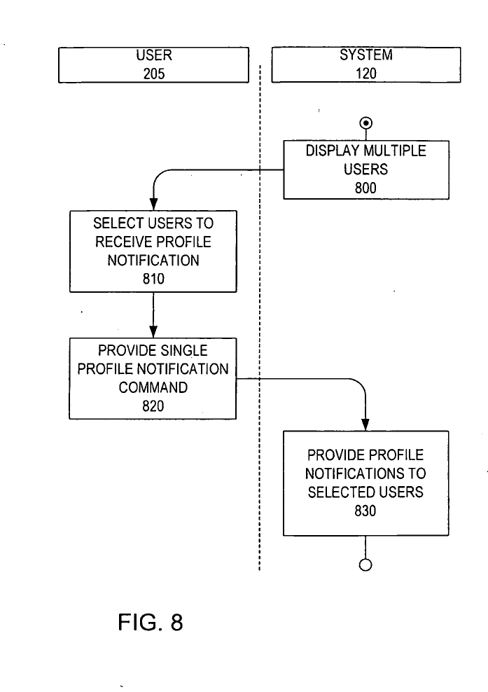

FIG. 8 illustrates an example of single command notification process associated with an online profile in accordance with one embodiment. In the embodiment illustrated in FIG. 8, system 120 can display (step 800) a listing of multiple users of system 120 for user 205. In response, user 205 can select (step 810) a number of the displayed users to receive a notification to view or access user 205's online profile, and provide a single profile notification command (step 820) to system 120. In one embodiment, the single notification command can comprise a single click in a user interface provided by system 120. In response to receiving the single profile notification command, system 120 can provide (step 830) profile notifications to the selected users. In one embodiment, the listed users of system 120 can correspond to employers, for example, who may be willing to view another user's online profile, such as the profile associated with user 205 who can correspond to an applicant for example.

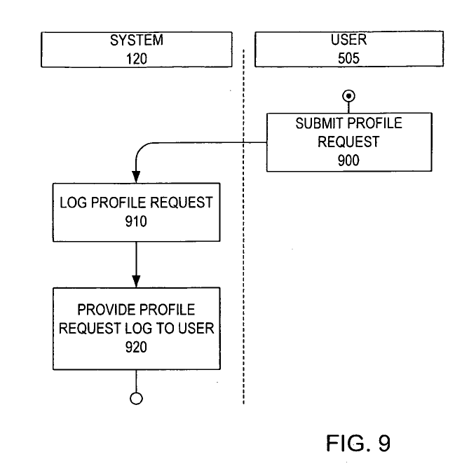

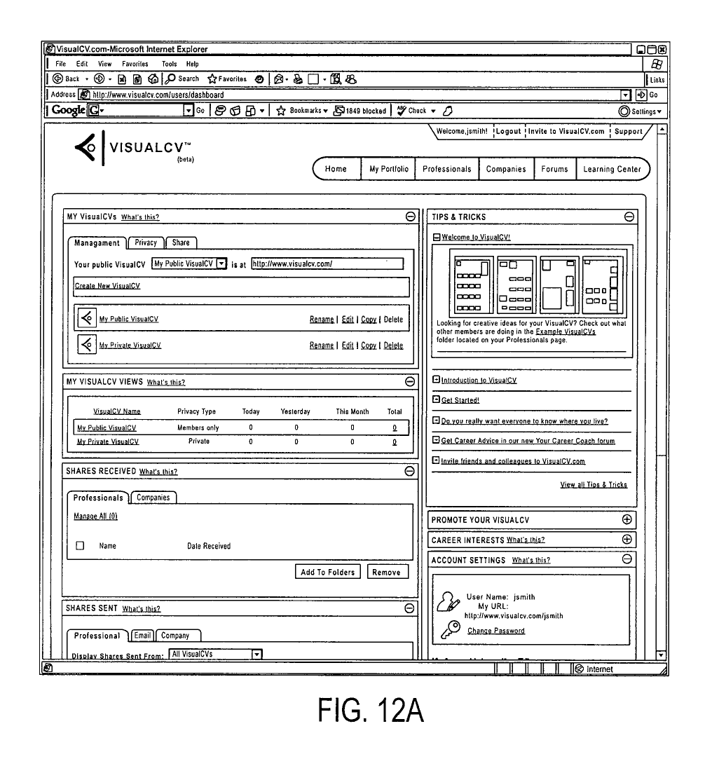

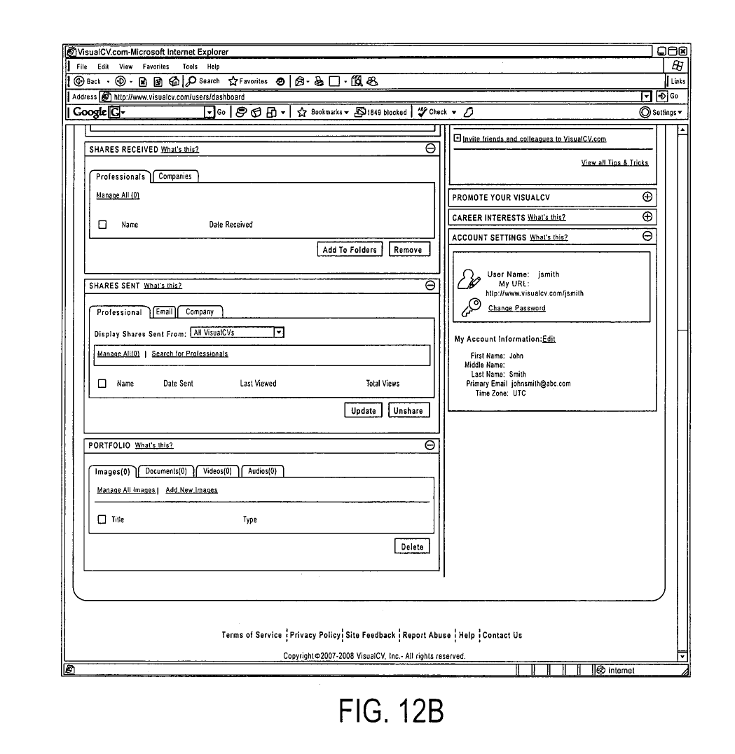

FIG. 9 illustrates an example of profile view tracking process in accordance with one embodiment. In the embodiment illustrated in FIG. 9, when user 505 submits (step 900) a request to view an online profile hosted by system 120, system 120 can log (step 910) the profile request and provide (step 920) the profile request log associated with a particular online profile to the user associated with the requested online profile. In one embodiment, the logged information can be presented to the user in a user portal or “dashboard” provided by system 120. In this manner, users with online profiles can gauge an amount of interest expressed by others in their profiles. A view can comprise, for example, an unsolicited viewing of a user's online profile by an entity browsing through public profiles presented by system 120 (via a public web page, for example), and/or a viewing in response to an invitation (or “share”) sent by a user to view the user's online profile. Different types of views can be tracked separately as indicated in the example user interface dashboard of FIGS. 12A and 12B.

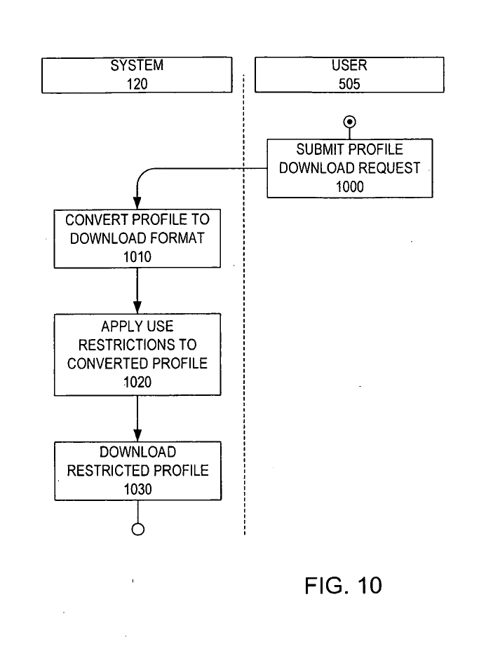

FIG. 10 illustrates an example of a profile distribution process in accordance with one embodiment. In the embodiment illustrated in FIG. 10, user 505 can request (step 1000) a copy of an online profile to be downloaded rather than viewed over network 105. In response to the request, system 120 can convert (step 1010) the requested online profile to a downloadable format and apply (step 10120) one or more use restrictions to the converted profile. System 120 can then download (step 1030) the converted and restricted profile to user 505. In one embodiment, the use restrictions may include an expiration date associated with the converted profile (e.g., to prevent retention of an out-of-date resume), a restriction on an ability to change the contents of the converted profile (e.g., to prevent tampering), and/or a restriction on an ability to view the converted profile more than a specified number of times. System 120 may provide a user interface enabling a user with an online profile to specify which, if any, use restrictions to associate with the profile when a download request is received in connection with that profile. The online profile may be converted into any suitable file format capable of enforcing the use restrictions or other digital rights management provided by system 120 and specified by the user.

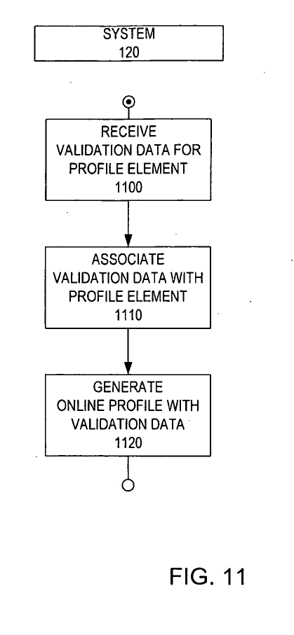

FIG. 11 illustrates an example of a profile verification process in accordance with one embodiment. In the embodiment illustrated in FIG. 11, server 120 can receive (step 1100) validation data for an element of a user's online profile. The validation data may be provided by a certifying authority, for example, and certify a representation provided by the element of the online profile. For example, the profile element could represent that an individual has acquired a professional license, and the certifying authority could provide suitable evidence, according to the best practices in the industry, to certify that representation. Upon receiving the validation data, server 120 can associate (step 1110) the validation data with the online profile element to which it corresponds, and generate (1120) the online profile incorporating the online profile element and the validation data. The validation data may be incorporated into the online profile in a secure manner to avoid tampering. The system can also provide a notification process that would alert the user when a professional certification identified in the online portfolio is due for renewal, for example.

FIGS. 12A and 12B illustrate an example of a user dashboard in accordance with one embodiment. In the embodiment illustrated in FIG. 12, the user dashboard acts as a home user interface that is provided for a registered and logged in user named John Smith in system 120. The dashboard enables the user to manage the associated online profiles (“My Public VisualCV” and “My Private VisualCV”), track views of the profile versions in the “MY VISUALCV VIEWS” section, track profile notifications received from other registered users of system 120 in the “SHARES RECEIVED” section, track profile notifications sent to others in the “SHARES SENT” section, and manage media objects that can be uploaded for incorporation into the online profile versions in the “PORTFOLIO” SECTION.”

FIGS. 13A-13C illustrate an example of a profile generation user interface that can be presented when the “Edit” link for the “My Public VisualCV” profile is clicked in the dashboard illustrated FIG. 12A. In the embodiment illustrated in FIG. 13A, the profile generation user interface can specify several predefined biographical categories (including “Objective,” “Work History,” “Education,” “Summary,” etc.) and can enable the user to specify one or more custom biographical categories (e.g., upon clicking the “Custom” or “Portfolio” category, for example). In the illustrated profile generation user interface spanning FIGS. 13A-13C, a “Work History” section and a “Custom” section is provided to receive user input in the main column, and a “Portfolio” section is provided to receive user input in the sidebar. As illustrated in FIG. 13C, by clicking on the chain link icon in the “Custom” section, the user interface can provide a pop-up window to enable the user to incorporate a media object or web link (referred to as “portfolio items”) into the online profile to increase its effectiveness.

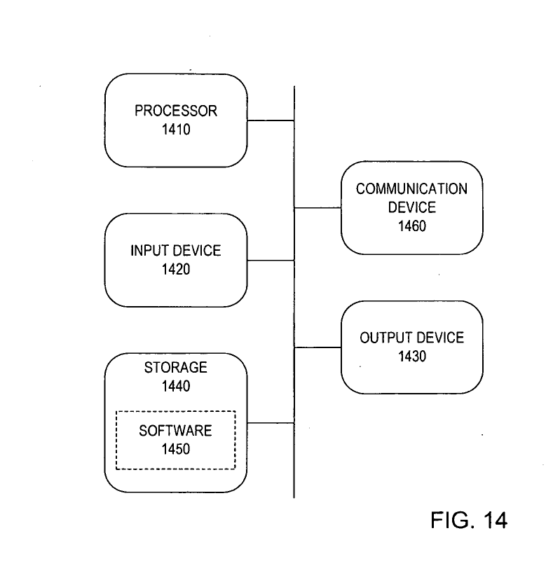

FIG. 14 illustrates an example of computing device in accordance with one embodiment. In the embodiment illustrated in FIG. 14, the computing device may generally correspond to client 100 and server 130 as described above. The computing device may be any suitable type of microprocessor-based device, such as, for example, a personal computer, workstation, server or handheld computing device. The computing device may include, for example, one or more of processor 1410, input device 1420, output device 1430, storage 1440, and communication device 1460.

Input device 1420 may be any suitable device that provides input, such as, for example, a keyboard, mouse, pen-operated touch screen or monitor, or voice-recognition device. Output device 1430 may be any suitable device that provides output, such as, for example, a monitor, printer, disk drive, or speaker.

Storage 1440 may be any suitable device the provides storage, such as, for example, an electrical, magnetic or optical memory including a RAM, cache, hard drive, CD-ROM drive, tape drive or removable storage disk. Communication device 1460 may include any suitable device capable of transmitting and receiving signals over a network, such as, for example, a network interface card or modem. The components of the computing device may be connected in any suitable manner, such as, for example, via a physical bus or wirelessly.

Software 1450, which may be stored in storage 1440 and executed by processor 1410, may include, for example, the application programming that embodies the functionality of the present invention (e.g., as embodied in server 130). In some embodiments, software 1450 may include a combination of servers such as application servers and database servers.

Network 105 may include any suitable type of interconnected communication system. Network 105 may implement any suitable communications protocol and may be secured by any suitable security protocol. Network 105 can include network links of any suitable arrangement that implements the transmission and reception of network signals, such as, for example, telephone lines, DSL, cable networks, T1 or T3 lines, or wireless network connections.

The computing device may implement any suitable operating system, such as, for example, Windows or UNIX. Software 1450 may be written in any suitable programming language, such as, for example, C, C++, Java or Visual Basic. In various embodiments, application software embodying the functionality of the present invention may be deployed in different configurations, such as, for example, on a standalone machine, in a client/server arrangement or through a Web browser as a Web-based application or Web service, for example.

Although the claimed subject matter has been fully described in connection with examples thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A method, comprising:
providing a user interface configured to enable a user of an online profile management system to create different versions of an online profile of an entity;
generating the different versions of the online profile based on different types of media provided by the user; and
controlling access to the different versions of the online profile based on one or more version access settings provided by the user.

2. The method of claim 1, wherein the different types of media include at least three of text, image, chart, video, audio and multimedia document.

3. The method of claim 1, wherein the controlling access includes revoking access to one or more of the different versions of the online profile.

4. The method of claim 1, wherein the one or more version access settings specify who is authorized to accessed which version of the online profile.

5. The method of claim 1, wherein one or more first sections of a version of the online profile is generated based on input provided by the user in accordance with a predefined biographical category specified by the user interface, and wherein one or more second sections of the version of the online profile are generated based on input provided by the user in accordance with a custom biographical category specified by the user through the user interface.

6. The method of claim 1, further comprising:
providing a notification that the online profile is available for viewing.

7. The method of claim 6, wherein the notification is provided based on one or more notification settings provided by the user.

8. The method of claim 7, wherein the one or more notification settings specify who is to be notified upon completion of an update to the online profile.

9. The method of claim 6, wherein the notification is provided internally within the online profile management system to one or more other users of the system.

10. The method of claim 6, wherein the notification is provided outside of the online profile management system over a network.

11. The method of claim 1, further comprising:
tracking one or more views of the online profile.

12. The method of claim 10, further comprising:
displaying a log of the tracked one or more views to the user.

13. The method of claim 1, further comprising:
controlling distribution of the online profile based on one or more use restriction settings provided by the user.

14. An online profile management system, comprising:
a profile creator configured to enable a user of the online profile management system to create an online profile of an entity; and
a profile provider configured to convert the online profile to a downloadable format and to apply to the converted profile one or more use restrictions provided by the user.

15. The system of claim 14, wherein the profile provider delivers the converted profile over a network.

16. The system of claim 14, wherein the one or more use restrictions includes an expiration date associated with the converted profile.

17. The system of claim 14, wherein the one or more use restrictions includes a restriction on an ability to view the converted profile more than a specified number of times.

18. The system of claim 14, wherein the one or more use restrictions includes a restriction on an ability to change the converted profile.

19. A method, comprising:
providing a system to host different versions of an online profile associated with a user of the system;
displaying other users of the system to the user;
receiving from the user a selection of a plurality of the other users and a single notification command; and
providing, in response to the single notification command, a notification to the selected plurality of other users to view the online profile of the user.

20. The method of claim 19, wherein the user of the system represents an applicant seeking an employment position, and the other users of the system represent companies.

21. An online profile management system, comprising:
a profile creator configured to enable a user of the online profile management system to create an online profile;
a profile validator configured to associate validation data with an element of the online profile, the validation data certifying a representation provided by the element of the online profile; and
a profile generator configured to generate the online profile incorporating the online profile element and the validation data.

22. The system of claim 21, further comprising:
a profile provider configured to convert the online profile to a downloadable format and to apply to the converted profile one or more use restrictions provided by the user.

23. The system of claim 21, further comprising:
a profile notifier configured to alert the user when a certification associated with the online profile element is due for renewal.
